(19) United States
(12) Patent Application Publication
(10) Pub. No.: US 2024/0176482 A1
(43) Pub. Date: May 30, 2024

(54) Gesture Based Space Adjustment for Editing

(71) Applicant: Microsoft Technology Licensing, LLC, Redmond, WA (US)

(72) Inventors: Erica Simone Martin, Redmond, WA (US); Mansi VASHISHT, Seattle, WA (US)

(21) Appl. No.: 18/071,406

(22) Filed: Nov. 29, 2022

(51) Int. Cl. G06F 3/04883; G06F 3/04845; G06F 3/0485

(52) U.S. Cl. CPC G06F 3/04883; G06F 3/04845; G06F 3/0485

(57) ABSTRACT

A computer implemented method includes receiving a gesture input associated with a document, detecting a hold of the gesture input, processing the gesture input in response to detection of the hold to identify a space adjustment in the document, and editing the document to adjust spacing using the space adjustment.

### BACKGROUND

Devices with touchscreens may be used for drawing using a finger, pen, or other type of pointing device. In an ink mode, graphics may be drawn. In an ink to text mode, pointing device written text that is entered is converted to digital text representations and displayed using a selected font. In the ink to text mode, spacing in text may also be modified with certain spacing gestures. Space between two letters for inserting text may be added by simply holding down the pointing device at the point where space is desired. Other editing functions may also be performed, such as drawing a line between two words to separate them or bring them together. A line drawn in the middle of a word will split the word into two words. A line at the end of word will create a line break, and a line at the end of line will create a new paragraph.

These space modification gestures operate well while in the ink to text mode. However, in an ink mode used for drawing graphics, such as drawings, and even text that is not to be converted to digital text representations, the spacing gestures are not effective, as they may be simply interpreted as more graphic input.

### SUMMARY

A computer implemented method includes receiving a gesture input associated with a document, detecting a hold of the gesture input, processing the gesture input in response to detection of the hold to identify a space adjustment in the document, and editing the document to adjust spacing using the space adjustment.

### BRIEF DESCRIPTION OF THE DRAWINGS

FIG. 1 is a diagram illustrating a gesture for identifying a point in a document at which spacing in the document is to be adjusted according to an example embodiment.

FIG. 2 is an example illustrating the use of a space adjustment gesture to insert one or more lines in a document according to an example embodiment.

FIG. 3 is a flowchart illustrating a method of utilizing space adjusting gestures to adjust spacing in a document according to an example embodiment.

FIG. 4 is an example illustrating the use of a space adjustment gesture to insert one or more lines in a document according to an example embodiment.

FIG. 5 is a representation of a screen shot illustrating user drawing interaction in an ink or drawing only mode to adjust vertical space according to an example embodiment.

FIG. 6 is a representation of a screen shot illustrating a document with a user drawing interaction in an ink or drawing only mode that has resulted in the insertion of horizontal space according to an example embodiment.

FIG. 7 is a representation of a screen shot illustrating a document with a user drawing interaction in an ink or drawing only mode that has resulted in the insertion of horizontal space according to an example embodiment.

FIG. 8 is a representation illustrating sequences of user drawing interaction in an ink or drawing only mode and resulting space adjustments according to an example embodiment.

FIG. 9 is a representation illustrating sequences of user drawing interaction in an ink to text mode and resulting space adjustments according to an example embodiment.

FIG. 10 is a representation illustrating sequences of user drawing interaction in an ink to text mode to add hand-written text in adjusted space according to an example embodiment.

FIG. 11 is a block schematic diagram of a computer system to implement one or more example embodiments.

FIG. 12 is a block diagram of a digital inking system according to an example embodiment.

FIG. 13 is a block diagram of a user device and a digital pen included in the digital inking system of FIG. 12 according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

A gesture recognition system receives gesture information representing one or more space adjustment gestures performed by a user while editing a document. The gestures may be performed using an input device interacting with a display device that is displaying the document. The input device may be a pen, finger, or other pointing device that can be used to draw shapes or handwriting.

In one example, space in a document can be adjusted while performing handwriting or drawing without switching input modes, such as switching from a drawing to a drawing to text mode. The space adjustment gesture is drawn, and then the pointing device, such as a pen, is held in position. After a selected amount of time at the end of the space adjustment gesture, a spacing is adjusted in the document. The amount of space added or removed depends on a direction and position of the space adjustment gesture.

If it is detected that the pen is held in position, such as continuously touching the display, the pen can be moved, or dragged to create more space or remove space. If further pen interaction for drawing or writing does not occur after a timeout a space will be created. If further writing is detected before the timeout, the writing may be converted text that will be inserted in the adjusted space.

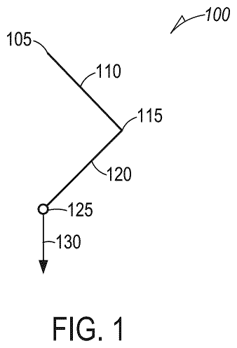

FIG. 1 is a diagram illustrating a gesture 100 for identifying a point in a document at which spacing in the document is to be adjusted. The gesture 100 may be hand drawn by a user on a display device screen of a computer system, such as a touchpad, touchscreen, or other device having a screen capable of receiving user drawing input. In one example, a stylus, finger, or electronic pen may be used as an input device to draw on the screen.

Gesture 100, also referred to as a space adjustment gesture, may be drawn as a caret shape or greater than symbol shape in one example as shown. Other shapes may be used in further examples. The input device may start on the screen at 105, proceed along leg 110 to point 115, and change directions, proceeding along leg 120 to end point 125 to complete the gesture 100.

At this point, the computer system may be in one of multiple different drawing entry modes. In a first mode, drawing using the input device may simply be interpreted, recorded, and displayed as graphical markings. In other words, if a letter or symbol or geometric shape is drawn, it will be shown exactly as drawn. In some systems, the first mode is known as an ink mode, and is analogous to simply drawing with a pen or pencil on actual paper.

In a second drawing entry mode, referred to as an ink to text mode, the system will attempt to convert the drawings into letters and words in digital form and display such letters and words in a selected font. In either mode, the system may also recognize certain gestures, differentiating the gesture from regular ink strokes, and intelligently clean them up such as by straightening lines of the gesture. A user may draw a shape, which may be recognized and made clean and neat.

Upon completion of the gesture 100 as described above, in the first mode, the ink mode, the gesture 100 would normally be interpreted as simply a drawing to be added to the document. To ensure that gesture 100 is interpreted as a space adjustment gesture, the input device may maintain contact with the screen during the drawing of the gesture 100 and may pause at 125 for a predetermined amount of time, such as at least 400 ms or other user selectable amount of time. This amount of time that the input device pauses, while maintaining contact with the screen, may be referred to as a space adjustment gesture pause threshold time. Upon detecting passage of this time, the gesture 100 is interpreted by the system as a space adjustment gesture regardless of input mode.

The gesture 100, as drawn, is usually used to signify that space is to be added between lines of text or objects, such as graphics. This same gesture may be drawn to look like a less than symbol for use at a right side between lines of text or rotated 90 degrees such that point 115 is on top or on the bottom of the gesture 100 for adjusting space between letters or objects in a row. Different positions for gesture 100 for adjusting space in different contexts are shown in further examples described below.

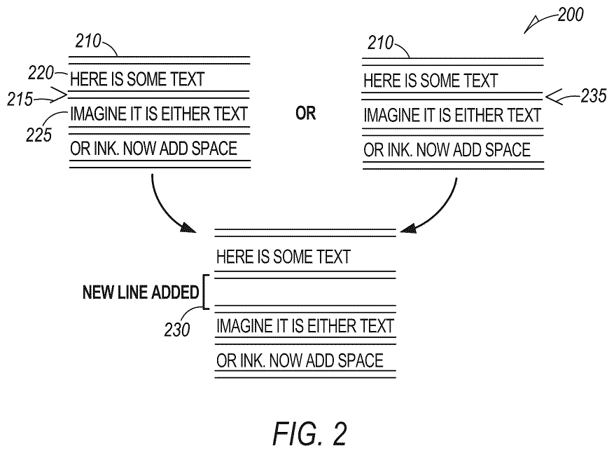

FIG. 2 is an example illustrating the use of a space adjustment gesture to insert one or more lines in a document generally at 200. Three lines of text are shown displayed on a screen at 210. A space adjustment gesture 215 is detected by a system as having been drawn on the screen, including the sufficient pause between a first line of text 220 and a second line of text 225. The lines of text are shown again with a new line 230 inserted between the first line of text 220 and the second line of text 225. Gesture 215 is the same shape as gesture 100. Also shown is a repeat of the lines of text at 210 with a space adjustment gesture 235 shown as a mirror image of gesture 215. Note the position of gesture 235 is on the right, or end of the lines of text, while gesture 215 is shown at the beginning or left of the lines of text. Both gesture 215 and 235 result in the same new line 230 being added.

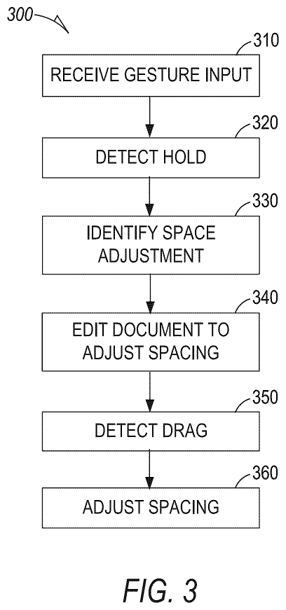

FIG. 3 is a flowchart illustrating a method 300 of utilizing space adjusting gestures to adjust spacing in a document. Method 300 begins at operation 310 by receiving a space adjustment gesture, such as a caret shape input associated with a document. A space adjustment gesture may be detected via a fairly simple neural network image recognition model in one example trained on hundreds if not thousands of example drawings by different users of the caret shape drawn in different orientations.

At operation 320, a pause or hold is detected at the end or completion of the gesture to help identify the gesture as a space adjustment gesture. The gesture input is processed at operation 330 in response to detection of the hold to identify a space adjustment in the document. Operation 340 edits the document to adjust spacing using the identified space adjustment.

The gesture may be input via a pen and detected via a touch screen displaying the document. The hold may be detected after the pen is held on the touch screen for 400 ms or more of holding the pen on the touch screen.

The position and direction of the caret shape drawn on the document determine a type of space adjustment. A caret shape pointing between letters in a word results in inserting a single space between the letters. A caret shape pointing between two lines of text results in adding a line between the two lines of text. A caret shape pointing between an end of a sentence and a beginning of a next sentence result in adding several spaces between the sentences.

In one example, following the detection of the hold at operation 320, a drag gesture or movement of the pointing device may be detected at operation 350. The length of the drag is used to determine the size of the space to insert in the document as indicated at operation 360. If inserting lines, the drag may be downward, with an end of the drag being detected and the number of lines inserted being commensurate with the distance between the end of the caret shape and the end of the drag.

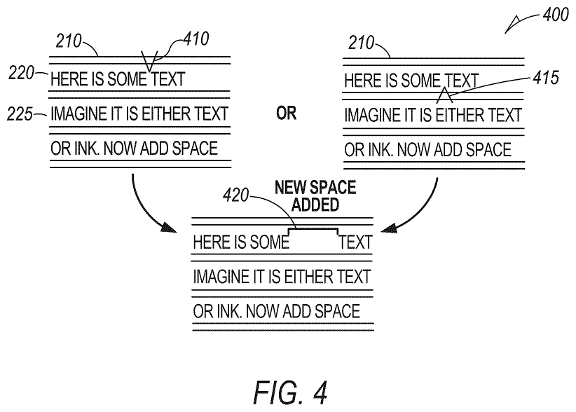

FIG. 4 is an example illustrating the use of a space adjustment gesture to insert one or more lines in a document generally at 400. The same three lines of text as used in a previous example are shown displayed on a screen at 210. A space adjustment gesture 410 is detected by a system as having been drawn on the screen between the words “some” and “text” in line of text 220. The lines of text are shown again with a space 420 inserted between the words “some” and “text” in line of text 220. Gesture 410 is the same shape as gesture 100, just rotated to point upward. Also shown is a repeat of the lines of text at 210 with a space adjustment gesture 415 shown as an upside-down image of gesture 410. Note the position of gesture 415 also points between the words “some” and “text” in line of text 220. Both gesture 410 and 415 result in the same space 420 being added.

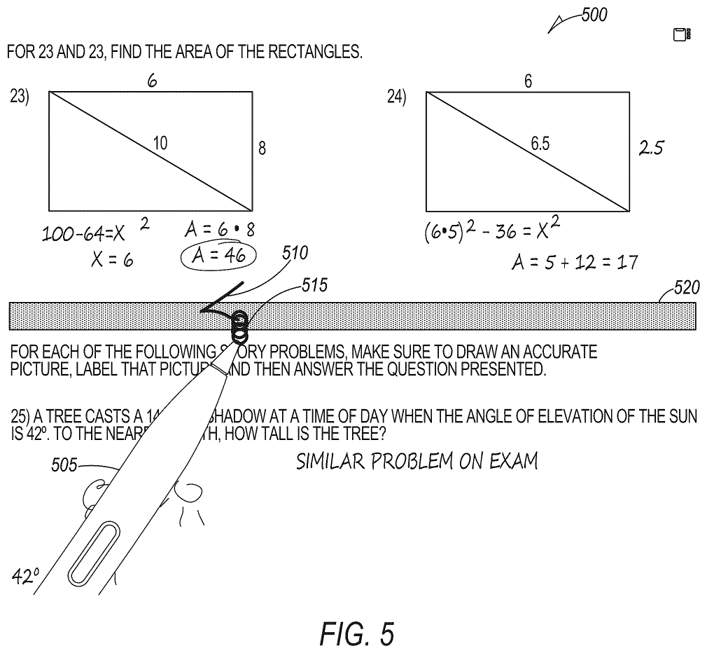

FIG. 5 is a representation of a screen shot 500 illustrating user drawing interaction in an ink or drawing only mode to adjust vertical space. An input device 505 is shown has having drawn a space adjustment gesture 510 between already drawn equations and existing computer generated text. Following a pause, the input device 505 is shown has having been dragged downward as indicated at 515 in order to create additional vertical space 520 commensurate with the length of the drag. The amount of the vertical space 520 is shown as matching the length of the drag at 515 in ink mode and is not directly related to inserting lines corresponding to text spacing, such as in a word processing application. Since ink mode is being used, gestures are not being converted to text. The pause is used to distinguish the gesture 510 from simply being another drawing. The indication of the drag at 515 may or may not be visible to a user in various examples, as the position of the pointing device itself may provide a sufficient visual cue to the user regarding the amount of space to be inserted.

Space adjustment gestures may also be used to reduce spacing between objects or text. For example, the drag at 510 may be performed in an upward direction to reduce the spacing between the hand entered formulas and the text below. Similarly, space between objects in a row or letters or words in a line of text may be reduced by drawing the gesture near end of the space, and dragging toward the beginning of the space to reduce the size of the space.

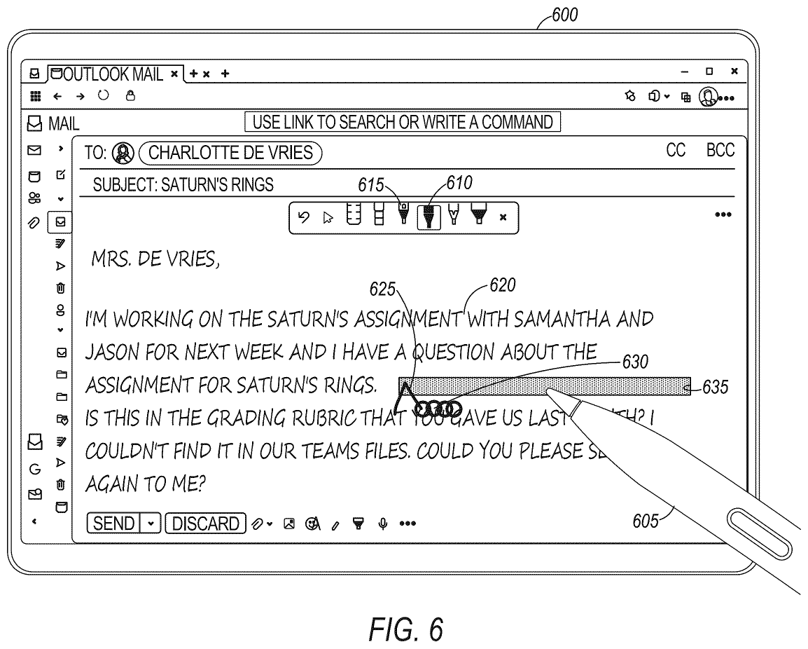

FIG. 6 is a representation of a screen shot 600 illustrating a document with a user drawing interaction in an ink or drawing only mode that has resulted in the insertion of horizontal space. An input device 605 is shown and may have been used to input handwriting and other drawing. An ink mode icon 610 is shown as having been selected. An ink to text mode icon 615 is also shown but has not been selected. Handwritten text 620 is shown and a space adjustment gesture 625 along with a drag indication 630 is also illustrated. The space adjustment gesture 625 is shown following the text “Saturn's rings” and is pointing upward, indicating a desire to insert horizontal space. Drag indication 630 extends to the right of the text “Saturn's rings” indicating the desire to insert more than a default amount of space. In one example, the drag indication 630 creates an amount of space to the right, indicated at 635, corresponding to a length of the remainder of the document real estate. Alternatively, the amount of space may be proportional or identical to the length of the drag.

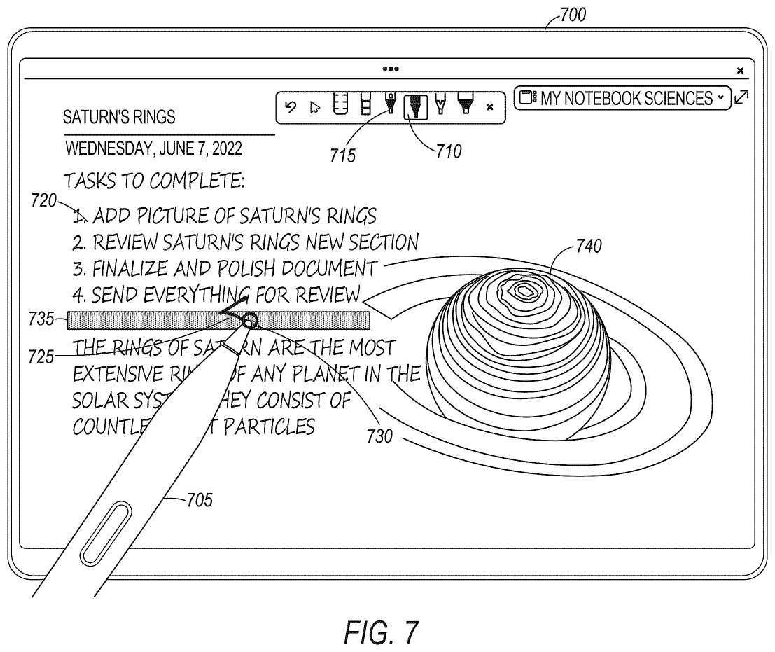

FIG. 7 is a representation of a screen shot 700 illustrating a document with a user drawing interaction in an ink or drawing only mode that has resulted in the insertion of horizontal space. An input device 705 is shown and may have been used to input handwriting and other drawing. An ink mode icon 710 is shown as having been selected. An ink to text mode icon 715 is also shown but has not been selected. Handwritten text 720 is shown and a space adjustment gesture 725 along with a drag indication 730 is also illustrated. The space adjustment gesture 725 is shown between lines of text and is pointing toward the left, indicating a desire to insert vertical space in the displayed document. Drag indication 730 extends downward indicating the desire to insert more than a default amount of space. In one example, the drag indication 730 creates an amount of vertical space, indicated at 735, corresponding to a length of the drag indication 730. Screen shot 700 also display an image 740 that has been inserted into the document.

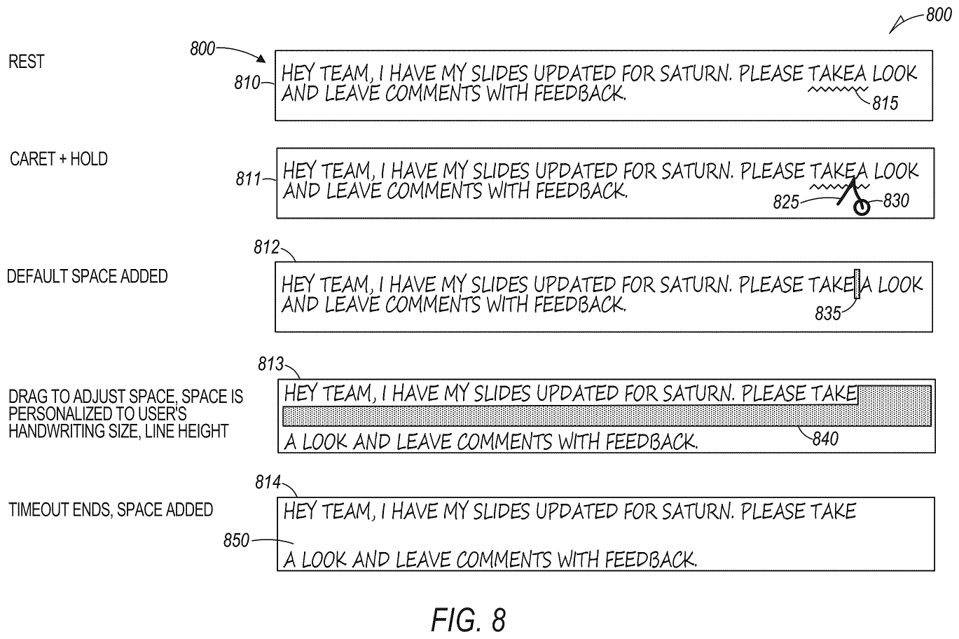

FIG. 8 is a representation 800 illustrating sequences of user drawing interaction in an ink or drawing only mode and resulting space adjustments. Handwritten text 810 is shown with various actions being taken over time as illustrated by the same text at 811, 812, 813, and 814. Text 810 includes two words that were written together without a space: “takea”. Text 810 is repeated at 811 and a space adjustment gesture 825 along with a pause or hold indicated at 830 is shown pointing between “take” and “a”. The result of the space adjustment gesture 825 is shown at 812 with a default amount of space 835 inserted between “take” and “a”. The default amount of space 835 may be determined as a function of the size of the text being interacted with in one example to maintain a consistent spacing between handwritten words.

A next edit to be performed is the addition of more than a default amount of space. Following the pause at 830, the user may perform a drag to adjust the space and personalize the space to the user's handwriting size, and desired line height. An example space that includes both horizontal space and vertical space is shown at space 840 in text 813. Space 840 may be highlighted as the user drags to indicate the amount of space that will be inserted once the user stops dragging. Text below may be moved as space 840 is highlighted or following lifting of the input device from the screen, resulting in blank space 850 shown in text 814. The drag in this example may have extended to the bottom of the space 840.

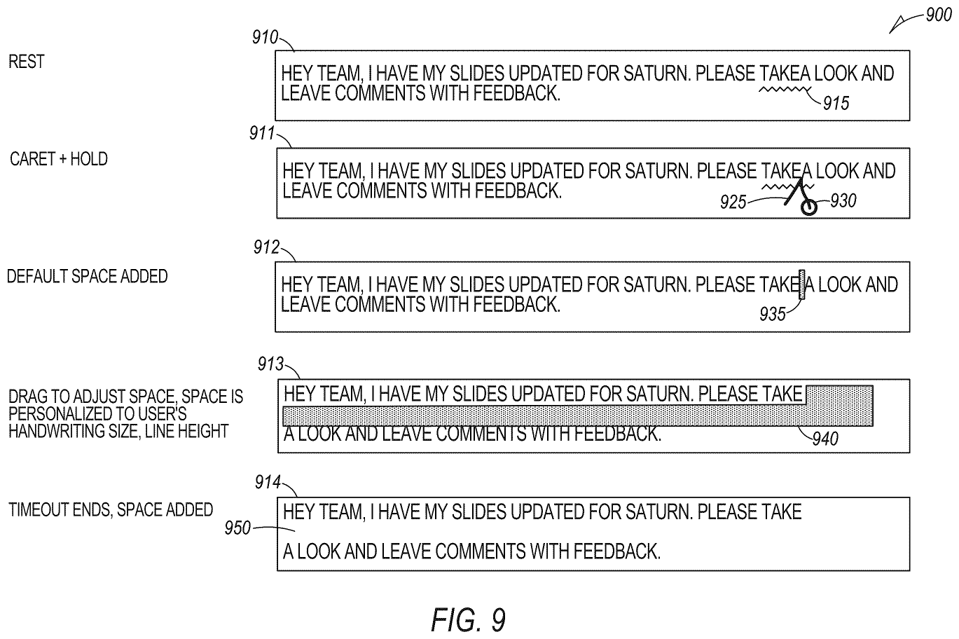

FIG. 9 is a representation 900 illustrating sequences of user drawing interaction in an ink to text mode and resulting space adjustments. Handwritten text 010 is shown with various actions being taken over time as illustrated by the same text at 911, 912, 913, and 914. Text 910 includes two words that were written and recognized or typed together without a space: “takea”. Text 910 is repeated at 911 and a space adjustment gesture 925 along with a pause or hold indicated at 930 is shown pointing between “take” and “a”. The result of the space adjustment gesture 925 is shown at 912 with a default amount of space 835 inserted between “take” and “a”. The default amount of space 835 may correspond to the size of the font of the text to maintain a consistent spacing between handwritten words.

A next edit to be performed is the addition of more than a default amount of space. Following the pause at 930, the user may perform a drag to adjust the space and personalize the space to the user's handwriting size, and desired line height. An example space that includes both horizontal space and vertical space is shown at space 940 in text 913. Space 940 may be highlighted as the user drags to indicate the amount of space that will be inserted once the user stops dragging. Text below may be moved as space 940 is highlighted or following lifting of the input device from the screen, resulting in blank space 950 shown in text 914. The drag in this example may have extended to the bottom of the space 940.

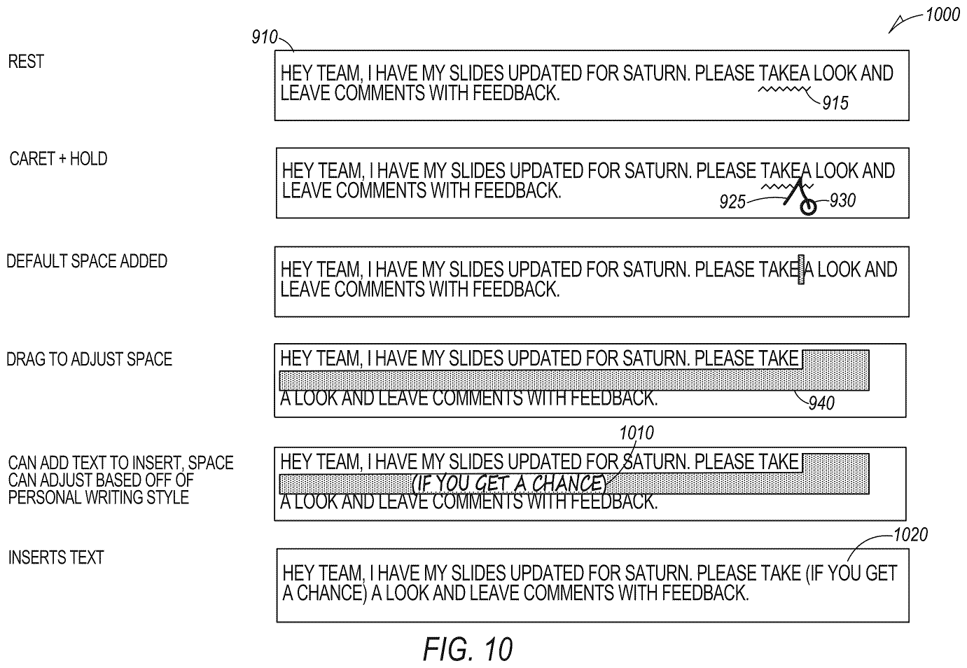

FIG. 10 is a representation 1000 illustrating sequences of user drawing interaction in an ink to text mode to add hand-written text in space 940 created as shown in FIG. 9 which uses consistent reference numbers. Once the space 940 is created using the space adjustment gesture, the user has written text 1010L “(if you get a chance)” using the input device in the created space 940. Following a text entry timeout, the text is both recognized and converted to digital format using the font and size of the previous text, and spacing is adjusted to format the recognized text into the previous text as shown at 1020. The text entry timeout may be one or two seconds, or other time from entry of text as specified by a user in corresponding settings for the ink to text mode.

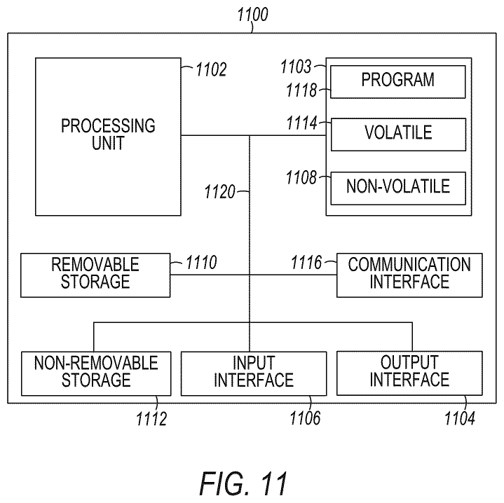

FIG. 11 is a block schematic diagram of a computer 1100 to receive drawing input, recognize space adjustment gestures, and modify spacing in displayed document, and for performing methods and algorithms according to example embodiments. All components need not be used in various embodiments.

One example computing device in the form of a computer 1100 may include a processing unit 1102, memory 1103, removable storage 1110, and non-removable storage 1112. Although the example computing device is illustrated and described as computer 1100, the computing device may be in different forms in different embodiments. For example, the computing device may instead be a smartphone, a tablet, smartwatch, smart storage device (SSD), or other computing device including the same or similar elements as illustrated and described with regard to FIG. 11. Devices, such as smartphones, tablets, and smartwatches, are generally collectively referred to as mobile devices or user equipment.

Although the various data storage elements are illustrated as part of the computer 1100, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 1103 may include volatile memory 1114 and non-volatile memory 1108. Computer 1100 may include—or have access to a computing environment that includes—a variety of computer-readable media, such as volatile memory 1114 and non-volatile memory 1108, removable storage 1110 and non-removable storage 1112. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 1100 may include or have access to a computing environment that includes input interface 1106, output interface 1104, and a communication interface 1116. Output interface 1104 may include a display device, such as a touchscreen, that also may serve as an input device. The input interface 1106 may include one or more of a touchscreen, touchpad, mouse, keyboard, camera, one or more device-specific buttons, one or more sensors integrated within or coupled via wired or wireless data connections to the computer 1100, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth. or other networks. According to one embodiment, the various components of computer 1100 are connected with a system bus 1120.

Computer-readable instructions stored on a computer-readable medium are executable by the processing unit 1102 of the computer 1100, such as a program 1118. The program 1118 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 1118 along with the workspace manager 1122 may be used to cause processing unit 1102 to perform one or more methods or algorithms described herein.

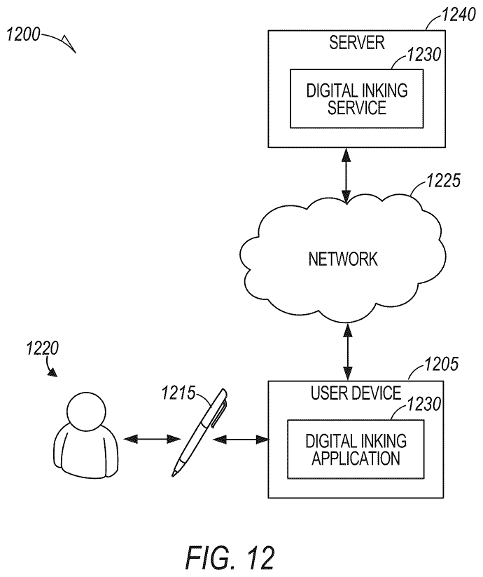

FIG. 12 is a block diagram of a digital inking system 1200 according to an example embodiment. System 1200 may be implemented using components of computer 1100 to perform gesture recognition for modifying space in a document. System 1200 includes a user computing device 1205 and a digital pen 1215. Non-limiting examples of the user computing device 1205 include a laptop computer, a desktop computer, a tablet computer, a mobile telephone, a personal digital assistant (PDA), a mobile email device, or another electronic device configured to perform digital inking or digital ink editing. As illustrated in FIG. 12, the user device 1205 receives input from the digital pen 1215 as operated or controlled by a user 1220. The digital pen 1215 can include a passive pen (e.g., a stylus) or an active pen.

The user device 1205 includes a digital inking application 1210. The digital inking application 1210 provides, within an electronic document, such as, for example, a digital journal, a canvas configured to receive digital ink via the digital pen 1215. In some embodiments, the digital inking application 1210 is a stand-alone application executed by the user device 1205 (an electronic processor included in the user device 1205) to provide the digital inking and digital ink editing functionality described herein. In other embodiments, however, the digital inking application 1210 may access or otherwise communicate with a digital inking service 1230 provided by a server 1240, which may provide one or more hosted services. In one example, the user device 1205 is connected to a network 1225 to communicate with the server 1240.

The network 1225 can include wired networks, wireless networks, or a combination thereof that enable communications between the various entities in the system 1200. In some configurations, the communication network 1225 includes cable networks, the Internet, local area networks (LANs), wide area networks (WAN), mobile telephone networks (MTNs), and other types of networks, possibly used in conjunction with one another, to facilitate communication between the user device 1205 and the server 1240.

In embodiments where the digital inking application 1210 communicates with the digital inking service 1230, the digital inking application 1210 installed on the user device 1205 may be a general purpose browser application configured to access various services and content over the network 1225, including the digital inking service 1230 provided by the server 1240. Alternatively, in this embodiment, the digital inking application 1210 installed on the user device 1205 may be a dedicated application configured to access the digital inking service 1230. Also, it should be understood that the functionality described herein as being performed by the digital inking application may be performed by the user device 1205, the server 1240, or a combination thereof where functionality may be distributed in various manners.

It should also be understood that the system 1200 illustrated in FIG. 12 is provided by way of example and the system 1200 may include additional or fewer components and may combine components and divide one or more components into additional components. For example, the system 1200 may include any number of user devices 1205 or networks 1225 and various intermediary devices may exist between a user device 1205 and the server 1240. Also, in some embodiments, multiple servers 1240 may be used to provide the digital inking service 1230, such as within a cloud computing environment.

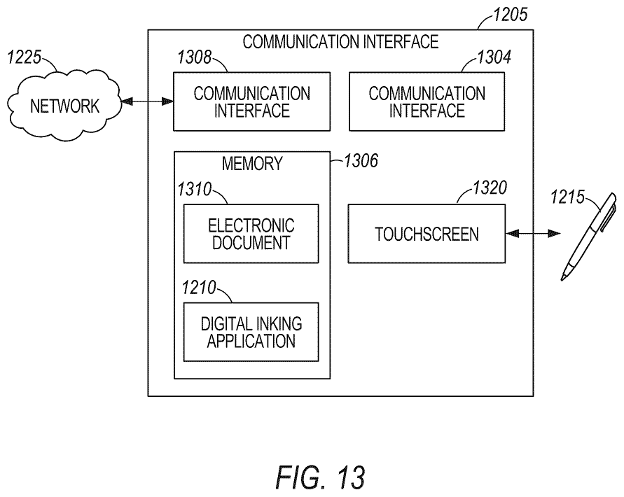

FIG. 13 is a block diagram of a user device and a digital pen included in the digital inking system of FIG. 12 according to an example embodiment. As illustrated in FIG. 13, the user device 1205 includes an electronic processor 1304, a computer-readable memory 1306, and a communication interface 1308. The electronic processor 1304, memory 1306, and communication interface 1308 communicate wirelessly, over one or more wired communication channels or busses, or a combination thereof (not illustrated).

The memory 1306 can include non-transitory memory, such as random access memory, read-only memory, or a combination thereof. The electronic processor 1304 can include a microprocessor, a microcontroller, a digital signal processor, or any combination thereof configured to execute instructions stored in the memory 1306. The memory 1306 can also store data used with and generated by execution of the instructions.

The communication interface 1308 allows the user device 1205 to communicate with external networks and devices, including, for example, the network 1225. For example, the communication interface 1308 may include a wireless transceiver for communicating with the network 1225. It should be understood that the user device 1205 may include additional or fewer components than those illustrated in FIG. 13 and may include components in various configurations. For example, in some embodiments, the user device 1205 includes a plurality of electronic processors, a plurality of memories, a plurality of communication interfaces, or a combination thereof. Also, in some embodiments, the user device 1205 includes additional input devices, output devices, or a combination thereof.

As illustrated in FIG. 13, the memory 1306 stores the digital inking application 1210. The digital inking application 1210 (as executed by the electronic processor 1304) provides a canvas (e.g., a digital journal) for receiving, displaying, and editing digital ink, including the editing functionality described above. In some embodiments, the memory 1306 also stores one or more electronic documents 1310, such as one or more digital journals generated via the digital inking application 1210. In some embodiments, the electronic documents 1310 may be stored in separate memory included in the user device 1205, in a memory external to the user device 1205 but accessible by the user device 1205 (e.g., via the communication interface 1308 or a dedicated port or interface), or in a combination thereof.

It should be understood that when the digital inking application 1210 described herein is used in a networked environment with the server 1240, each of the server 1240 may include similar components as the user device 1205 and, in particular, may include one or more electronic processors for executing applications or instructions that, when executed, provide the digital inking service 1230.

The user device 1205 also includes (or communicates with) a touchscreen 1320. The digital inking application 1210 (or a separate application or module) is configured to detect when the digital pen 1215 touches or otherwise interacts with the touchscreen 1320 (e.g., using capacitive technology). These detected positions can be translated to ink points and digital strokes via the digital inking application 1210, which can be used to generate and add digital ink to the canvas. As noted above, in some examples, the digital pen 1215 includes a passive pen. However, in other examples, the digital pen 1215 includes an active pen. An active pen, as compared to a passive pen, includes electronics or circuitry configured to communicate with a digitizer included in the touchscreen 1320. This communication allows the digital inking application 1210 to provide additional functionality as compared to when the digital pen 1215 includes a passive pen. For example, when the digital pen 1215 is an active pen, the digital inking application 1210 can provide functionality that uses or is responsive to pressure or touch sensitivity applied by the pen 1215, a tilt of the pen 1215, a position of the pen 1215 (such as a position of the pen even when the pen is hovering over but not touching the touchscreen 1320), activation of input mechanisms (e.g., buttons) on the pen 1215, use of an eraser tip of the pen 1215, or the like.

As described above, the digital inking application 1210 (as executed by the one or more electronic processors 1304) provides a canvas within an electronic document (e.g., as part of a digital journal) and is configured to detect digital strokes input via the digital pen 1215 and process the digital strokes to generate, add, and edit digital ink, and modify spacing within the canvas.

### Examples

1. A computer implemented method includes receiving a gesture input associated with a document, detecting a hold of the gesture input, processing the gesture input in response to detection of the hold to identify a space adjustment in the document, and editing the document to adjust spacing using the space adjustment.

2. The method of example 1 wherein the gesture comprises a caret shape.

3. The method of example 2 wherein the hold of the gesture is detected upon completion of the gesture.

4. the method of example 3 wherein the gesture is input via a pen touching a screen displaying the document.

5. The method of example 4 wherein the hold is detected after the pen is held on the screen.

6. The method of example 5 wherein the hold is detected after 400 ms or more of holding the pen on the screen.

7. The method of any of examples 2-6 wherein a caret shape pointing between letters in a word results in inserting a single space between the letters.

8. The method of any of examples 2-7 wherein a caret shape pointing between two lines of text results in adding a line between the two lines of text.

9. The method of any of examples 2-8 wherein a caret shape pointing between an end of a sentence and a beginning of a next sentence result in adding several spaces between the sentences.

10. The method of any of examples 1-9, further including detecting a drag gesture following the hold detection and wherein editing the document to adjust the spacing includes generating a space having a size determined by the drag gesture.

11. The method of any of examples 1-10 wherein a position and direction of a shape of the gesture determines a type of space adjustment.

12. The method of example 11 wherein the gesture includes a caret shape, and wherein the position and direction of the shape of the caret shape determines an initial size of the space adjustment.

13. The method of example 12, further including detecting a drag gesture following the hold detection and adjusting the initial size of the space adjustment based upon the drag gesture.

14. The method of any of examples 1-13 wherein the spacing is adjusted between words in document, the method further including receiving text input in the adjusted spacing, inserting the text in the adjusted space, and formatting the inserted text to adjust spaces between words in the document and the inserted text.

15. The method of example 14 wherein formatting occurs following a selected time from a last text input received.

16. A machine-readable storage device has instructions for execution by a processor of a machine to cause the processor to perform operations to perform any of the methods of examples 1-15.

17. A device includes a processor and a memory device coupled to the processor and having a program stored thereon for execution by the processor to perform any of the methods of examples 1-15.

The functions or algorithms described herein may be implemented in software in one embodiment. The software may consist of computer executable instructions stored on computer readable media or computer readable storage device such as one or more non-transitory memories or other type of hardware-based storage devices, either local or networked. Further, such functions correspond to modules, which may be software, hardware, firmware or any combination thereof. Multiple functions may be performed in one or more modules as desired, and the embodiments described are merely examples. The software may be executed on a digital signal processor. ASIC, microprocessor, or other type of processor operating on a computer system, such as a personal computer, server or other computer system, turning such computer system into a specifically programmed machine.

The functionality can be configured to perform an operation using, for instance, software, hardware, firmware, or the like. For example, the phrase “configured to” can refer to a logic circuit structure of a hardware element that is to implement the associated functionality. The phrase “configured to” can also refer to a logic circuit structure of a hardware element that is to implement the coding design of associated functionality of firmware or software. The term “module” refers to a structural element that can be implemented using any suitable hardware (e.g., a processor, among others), software (e.g., an application, among others), firmware, or any combination of hardware, software, and firmware. The term, “logic” encompasses any functionality for performing a task. For instance, each operation illustrated in the flowcharts corresponds to logic for performing that operation. An operation can be performed using, software, hardware, firmware, or the like. The terms, “component,” “system,” and the like may refer to computer-related entities, hardware, and software in execution, firmware, or combination thereof. A component may be a process running on a processor, an object, an executable, a program, a function, a subroutine, a computer, or a combination of software and hardware. The term. “processor,” may refer to a hardware component, such as a processing unit of a computer system.

Furthermore, the claimed subject matter may be implemented as a method, apparatus, or article of manufacture using standard programming and engineering techniques to produce software, firmware, hardware, or any combination thereof to control a computing device to implement the disclosed subject matter. The term, “article of manufacture,” as used herein is intended to encompass a computer program accessible from any computer-readable storage device or media. Computer-readable storage media can include, but are not limited to, magnetic storage devices, e.g., hard disk, floppy disk, magnetic strips, optical disk, compact disk (CD), digital versatile disk (DVD), smart cards, flash memory devices, among others. In contrast, computer-readable media, i.e., not storage media, may additionally include communication media such as transmission media for wireless signals and the like.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. A computer implemented method comprising:
receiving space adjusting gesture input associated with a document, the space adjusting gesture input comprising a shape;
detecting a pause in position at an end of the shape;
processing the space adjusting gesture input in response to detection of the pause to identify a space adjustment in the document; and
editing the document to adjust spacing using the space adjustment.

2. The method of claim 1 wherein the space adjusting gesture input comprises a caret shape.

3. The method of claim 2 wherein the pause of the space adjusting gesture input is detected upon completion of the space adjusting gesture input while in a drawing mode of input.

4. the method of claim 3 wherein the space adjusting gesture input is input via a pen touching a screen displaying the document.

5. The method of claim 4 wherein the pause is detected after the pen is held on the screen.

6. The method of claim 5 wherein the pause is detected after 400 ms or more of holding the pen on the screen.

7. The method of claim 2 wherein a caret shape pointing between letters in a word results in inserting a single space between the letters.

8. The method of claim 2 wherein a caret shape pointing between two lines of text results in adding a line between the two lines of text.

9. The method of claim 2 wherein a caret shape pointing between an end of a sentence and a beginning of a next sentence result in adding several spaces between the sentences.

10. The method of claim 1, further comprising:
detecting a drag gesture following the pause detection; and
wherein editing the document to adjust the spacing includes generating a space having a size determined by the drag gesture.

11. The method of claim 1 wherein a position and direction of the shape of the space adjusting gesture input determines a type of space adjustment wherein the space adjusting gesture input is received in an ink input mode, and wherein the document is edited without switching away from the ink input mode.

12. The method of claim 11 wherein the space adjusting gesture input comprises a caret shape, and wherein the position and direction of the shape of the caret shape determines an initial size of the space adjustment.

13. The method of claim 12, further comprising:
detecting a drag gesture following the pause detection; and
adjusting the initial size of the space adjustment based upon the drag gesture.

14. The method of claim 1 wherein the spacing is adjusted between words in document, the method further comprising:
receiving text input in the adjusted spacing;
inserting the text in the adjusted space; and
formatting the inserted text to adjust spaces between words in the document and the inserted text.

15. The method of claim 14 wherein formatting occurs following a selected time from a last text input received.

16. A non-transitory machine-readable storage device having instructions for execution by a processor of a machine to cause the processor to perform operations to perform a method, the operations comprising:
receiving space adjusting gesture input associated with a document, the space adjusting gesture input comprising a shape;
detecting a pause in position at an end of the shape;
processing the space adjusting gesture input in response to detection of the pause to identify a space adjustment in the document; and
editing the document to adjust spacing using the space adjustment.

17. The device of claim 16 wherein the pause of the space adjusting gesture input is detected upon completion of the gesture input.

18. The device of claim 16 wherein the operations further comprise:
detecting a drag gesture following the pause detection; and
wherein editing the document to adjust the spacing includes generating a space having a size determined by the drag gesture.

19. The device of claim 16 wherein the spacing is adjusted between words in document, the method further comprising:
receiving text input in the adjusted spacing;
inserting the text in the adjusted space; and
formatting the inserted text to adjust spaces between words in the document and the inserted text.

20. A device comprising:
a processor; and
a memory device coupled to the processor and having a program stored thereon for execution by the processor to perform operations comprising:
receiving space adjusting gesture input associated with a document, the space adjusting gesture input comprising a shape;
detecting a pause in position at an end of the shape;
processing the space adjusting gesture input in response to detection of the pause to identify a space adjustment in the document; and
editing the document to adjust spacing using the space adjustment.
